(19) United States
(12) Patent Application Publication
(10) Pub. No.: US 2025/0365068 A1
(43) Pub. Date: Nov. 27, 2025

(54) FAULTY SEGMENT ESTIMATION METHOD, FAULTY SEGMENT ESTIMATION SYSTEM, AND FAULTY SEGMENT ESTIMATION APPARATUS

(71) Applicant: NIPPON TELEGRAPH AND TELEPHONE CORPORATION, Tokyo (JP)

(72) Inventors: Takafumi TANAKA, Musashino-shi (JP); Shingo KAWAI, Musashino-shi (JP); Tetsuro INUI, Musashino-shi (JP)

(73) Assignee: NIPPON TELEGRAPH AND TELEPHONE CORPORATION, Tokyo (JP)

(21) Appl. No.: 18/873,036

(22) PCT Filed: Jun. 13, 2022
(86) PCT No.: PCT/JP2022/023626

§ 371 Date: Dec. 9, 2024

(51) Int. Cl. H04B 10/077; H04Q 11/00

(52) U.S. Cl. CPC H04B 10/0771; H04Q 11/0062; H04Q 2011/0083; H04Q 2213/054

(57) ABSTRACT

Provided is an abnormal section estimation method in a system in which an optical transmitter and an optical receiver are connected by an optical transmission line, the optical transmission line being divided into a plurality of sections at one or more monitoring points from the optical transmitter to the optical receiver, the abnormal section estimation method including: extracting, based on an optical signal transmitted from the optical transmitter, signal data on a complex plane of the optical signal expressed by phase and amplitude at the one or more monitoring points; acquiring an abnormality estimation result of at least one of the plurality of sections by inputting the signal data extracted at the one or more monitoring points to trained models trained to receive the signal data as input and output the abnormality estimation result; and estimating a section where an abnormality has occurred based on the acquired abnormality estimation result.

### TECHNICAL FIELD

The present invention relates to an abnormal section estimation method, an abnormal section estimation system, and an abnormal section estimation device.

### BACKGROUND ART

In maintenance and operation of optical networks, it is important to discover an abnormal state that may be a sign of failure early on, and to specify the location where the abnormal state occurs, before a communication interruption occurs. In the related art, an optical time domain reflectometer (OTDR) device has been used as a method for measuring the state of an optical transmission line such as an optical fiber. With an OTDR, it is possible to estimate the distance of an optical fiber, loss due to fusion splicing or connector connection, etc. from reflected light obtained by inputting an optical pulse into an optical fiber. Although the OTDR can estimate the point where a fiber abnormality has occurred with high accuracy, it requires the use of a dedicated measuring device, which poses a problem in that it is not economical in actual operation.

On the other hand, in recent years, a technology has been proposed in which digital coherent optical communication signals are added to data communication and used to evaluate signal quality (for example, see NPL 1). In the technology described in NPL 1, it is determined whether or not bending of an optical fiber has occurred in an optical transmission line by learning the shape of a signal received by a digital coherent optical receiver using machine learning. Thereby, it is possible to identify whether or not bending of the optical fiber has occurred using only information obtained from a transceiver used for data communication, without using dedicated equipment such as an OTDR. In this method, parameters input to machine learning are arbitrary, but in NPL 1, signal points on a complex plane of an optical signal before digital signal processing are used as input parameters. Although it can be estimated whether or not an abnormality such as optical fiber bending has occurred with this method, the position where the abnormality has occurred cannot be estimated.

In NPL 2, an optical power profile in the distance direction of an optical transmission line is estimated using information used for decoding in digital signal processing performed in an optical receiver. This position of optical power attenuation that occurs in an optical transmission line can be estimated with this method without using special equipment.

### CITATION LIST

### Non Patent Literature

[NPL 1] T. Tanaka, T. Inui, S. Kawai, S. Kuwabara, H. Nishizawa, “Monitoring and diagnostic technologies using deep neural networks for predictive optical network maintenance,” Journal of Optical Communication and Networking, vol. 13, No. 10, pp. E13-E22, October 2021.

[NPL 2] T. Tanimura, S. Yoshida, S. Oda, K. Tajima, T. Hoshida, “Advanced data-analytics-based fiber-longitudinal monitoring for optical transport networks,” 2020 European Conference on Optical Communications (ECOC), December 2020.

### SUMMARY OF INVENTION

### Technical Problem

In the method described in NPL 2, in order to estimate the position where an abnormality has occurred in an optical transmission line, a method using dedicated equipment and an estimation method using digital signal processing technology are proposed. However, both require the use of expensive equipment or signal processing circuits. On the other hand, although the method using machine learning described above does not require the use of dedicated equipment, when an attempt is made to estimate an abnormality in a signal including the position where the abnormality has occurred, the estimation accuracy will deteriorate as the number of labels to be estimated increases.

In view of the above circumstances, an object of the present invention is to provide a technology whereby a section in which an abnormality has occurred can be estimated with high accuracy while suppressing a calculation load.

### Solution to Problem

According to an aspect of the present invention, there is provided an abnormal section estimation method in a system in which an optical transmitter and an optical receiver are connected by an optical transmission line, the optical transmission line being divided into a plurality of sections at one or more monitoring points from the optical transmitter to the optical receiver, the abnormal section estimation method including: extracting, based on an optical signal transmitted from the optical transmitter, signal data on a complex plane of the optical signal expressed by a phase and an amplitude at the one or more monitoring points; acquiring an abnormality estimation result of at least one of the plurality of sections by inputting the signal data extracted at the one or more monitoring points to trained models that are trained to receive the signal data as an input and output the abnormality estimation result; and estimating a section in which an abnormality has occurred based on the acquired abnormality estimation result.

According to another aspect of the present invention, there is provided an abnormal section estimation system including: an optical transmitter that transmits an optical signal; an optical receiver that receives the optical signal transmitted from the optical transmitter; an optical transmission line that connects the optical transmitter and the optical receiver and is divided into a plurality of sections at one or more monitoring points from the optical transmitter to the optical receiver; one or more optical signal monitors that extract, based on an optical signal transmitted from the optical transmitter, signal data on a complex plane of the optical signal expressed by a phase and an amplitude at the one or more monitoring points; and an abnormal section estimation unit that estimates a section in which an abnormality has occurred based on an abnormality estimation result of at least one of the plurality of sections obtained by inputting the signal data extracted by the optical signal monitors at the one or more monitoring points to trained models that are trained to receive the signal data as an input and output the abnormality estimation result.

According to another aspect of the present invention, there is provided an abnormal section estimation device provided in a system in which an optical transmitter and an optical receiver are connected by an optical transmission line, the optical transmission line being divided into a plurality of sections at one or more monitoring points from the optical transmitter to the optical receiver, the abnormal section estimation device including: an abnormal section estimation unit that estimates a section in which an abnormality has occurred based on an abnormality estimation result of at least one of the plurality of sections obtained by inputting signal data obtained by one or more optical signal monitors that extract the signal data at the one or more monitoring points to trained models that are trained to receive, as an input, the signal data on a complex plane of an optical signal expressed by a phase and an amplitude obtained based on the optical signal transmitted from the optical transmitter and to output the abnormality estimation result.

### Advantageous Effects of Invention

According to the present invention, it is possible to estimate the section where an abnormality has occurred with high accuracy while suppressing the calculation load.

### BRIEF DESCRIPTION OF DRAWINGS

FIG. 1 A diagram showing a configuration example of an abnormal section estimation system according to a first embodiment.

FIG. 2 A diagram showing a configuration example of an optical signal monitor in the first embodiment.

FIG. 3 A diagram showing a configuration example of an optical receiver in the first embodiment.

FIG. 4 A diagram showing a configuration example of a learning device in the first embodiment.

FIG. 5 A diagram for describing processing of the learning device in the first embodiment.

FIG. 6 A diagram for describing an abnormal section estimation method performed by an abnormal section estimation device according to the first embodiment.

FIG. 7 A diagram for describing a third estimation method performed by an abnormal section estimation unit in the first embodiment.

FIG. 8 A flowchart showing a flow of processing of the third estimation method performed by the abnormal section estimation device according to the first embodiment.

FIG. 9 A sequence diagram showing a flow of processing of the abnormal section estimation system according to the first embodiment.

FIG. 10 A diagram showing a configuration example of an abnormal section estimation system according to a second embodiment.

FIG. 11 A diagram for describing a learning method of a machine learning model in a third embodiment.

FIG. 12 A diagram showing a configuration example of an abnormal section estimation system according to the third embodiment.

FIG. 13 A diagram showing a configuration example of an abnormal section estimation system according to a fourth embodiment.

### DESCRIPTION OF EMBODIMENTS

An embodiment of the present invention will be described below with reference to the drawings.

### First Embodiment

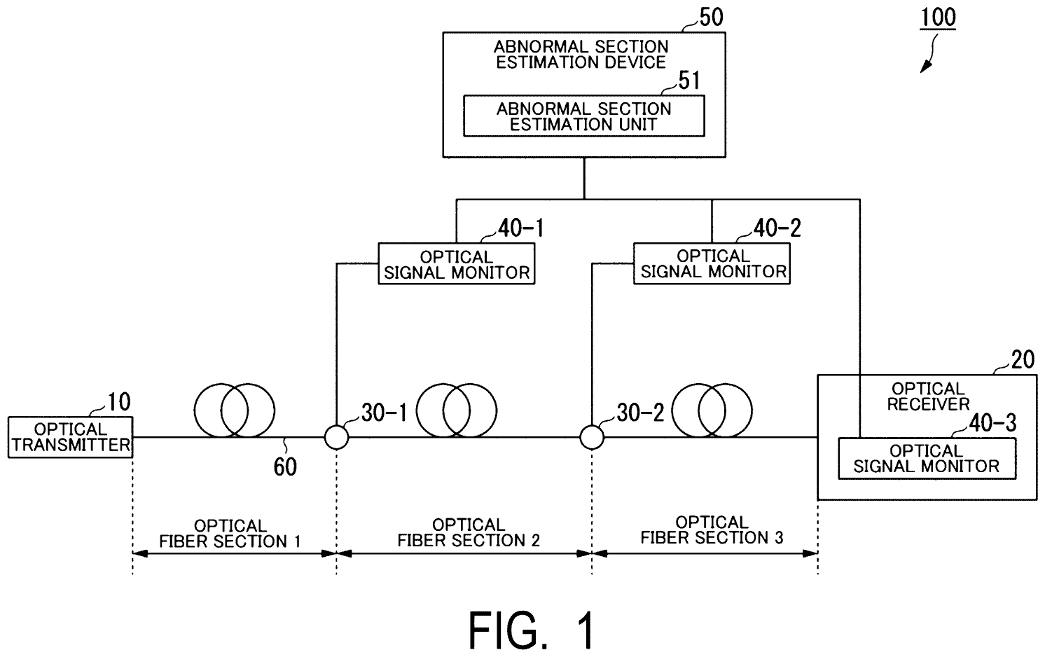

FIG. 1 is a diagram showing a configuration example of an abnormal section estimation system 100 according to a first embodiment. The abnormal section estimation system 100 is a system for estimating a section in which an abnormality has occurred in an optical transmission line. Abnormalities in optical transmission lines include attenuation of optical power due to bending of the optical transmission line, etc., and reduction in an optical signal-to-noise ratio (OSNR) due to malfunction of optical amplifiers.

The abnormal section estimation system 100 includes an optical transmitter 10, an optical receiver 20, one or more couplers/branchers 30, a plurality of optical signal monitors 40, and an abnormal section estimation device 50. Any number of couplers/branchers 30 may be provided as long as it is one or more, and any number of optical signal monitors 40 may be provided as long as it is two or more. FIG. 1 shows a configuration in which two couplers/branchers 30 (couplers/branchers 30-1 and 30-2) and three optical signal monitors 40 (optical signal monitors 40-1 to 40-3) are provided.

The optical transmitter 10 and the optical receiver 20 are connected by an optical transmission line 60 via the couplers/branchers 30-1 and 30-2. Note that an optical amplifier may be inserted at any location in the optical transmission line 60. Hereinafter, when there is no particular distinction between the couplers/branchers 30-1 and 30-2, they will simply be referred to as the couplers/branchers 30. Hereinafter, when there is no particular distinction between the optical signal monitors 40-1 to 40-3, they will simply be referred to as the optical signal monitors 40.

One or more monitoring points are provided between the optical transmitter 10 and the optical receiver 20. The monitoring point is a point where the optical signal propagating through the optical transmission line 60 is monitored. In the example shown in FIG. 1, the monitoring points are the positions where the couplers/branchers 30-1 and 30-2 are installed and the position of the optical receiver 20. Note that the monitoring points are not limited to the above. Hereinafter, the position where the coupler/brancher 30-1 is installed will also be referred to as a monitoring point 1, the position where the coupler/brancher 30-2 is installed will also be referred to as a monitoring point 2, and the position of the optical receiver 20 will also be referred to as a monitoring point 3.

As shown in FIG. 1, the optical transmission line 60 is divided into a plurality of sections by the coupler/brancher 30. That is, the optical transmission line 60 is divided into a plurality of sections at one or more monitoring points from the optical transmitter 10 to the optical receiver 20. The optical transmission line 60 is divided into different sections depending on the number of couplers/branchers 30. Each of these divided sections is a section on which abnormality estimation is performed. Hereinafter, the section between the optical transmitter 10 and the coupler/brancher 30-1 will be referred to as an optical fiber section 1, the section between the coupler/brancher 30-1 and the coupler/brancher 30-2 will be referred to as an optical fiber section 2, and the section between the coupler/brancher 30-2 and the optical receiver 20 will be referred to as an optical fiber section 3.

The optical transmitter 10 transmits an optical signal.

The optical receiver 20 receives the optical signal transmitted from the optical transmitter 10.

The optical receiver 20 includes the optical signal monitor 40-3.

The coupler/brancher 30 branches the optical signal propagating through the optical transmission line 60. For example, the coupler/brancher 30-1 branches an optical signal propagating through the optical transmission line 60 to the optical signal monitor 40-1 and the optical transmission line 60.

The optical signal monitor 40 receives, as an input, the optical signal branched by the coupler/brancher 30 or the optical signal propagated through the optical transmission line 60. For example, the optical signal monitor 40-1 acquires an optical signal at a monitoring point 1. The optical signal monitor 40-2 acquires an optical signal at a monitoring point 2. The optical signal monitor 40-3 acquires an optical signal at a monitoring point 3. The optical signal monitor 40 extracts a digitized optical signal using the input optical signal.

A digitized optical signal is signal data on a complex plane of an optical signal expressed by a phase and an amplitude. For example, a digitized optical signal is a constellation. Hereinafter, the digitized optical signal will be referred to as signal data. The optical signal monitor 40 in the first embodiment inputs signal data into a trained model and acquires an abnormality estimation result of the optical fiber section. The optical signal monitor 40 outputs the abnormality estimation result of the optical fiber section to the abnormal section estimation device 50.

The trained model is a model that is trained to receive signal data as an input and output an abnormality estimation result of at least one of a plurality of sections. The abnormality estimation result of the optical fiber section output by the trained model is, for example, any of normal, abnormality of the optical fiber section 1, abnormality of the optical fiber section 2, or abnormality of the optical fiber section 3. Note that the abnormality estimation results of optical fiber sections output by the trained model shown here are merely examples, and the output estimation results differ depending on the number of sections. Furthermore, in the first embodiment, trained models trained by different learning methods are used for each optical signal monitor 40. A specific description will be given later.

The abnormal section estimation device 50 includes an abnormal section estimation unit 51. The abnormal section estimation unit 51 estimates the section in which the abnormality has occurred based on the abnormality estimation results of the optical fiber sections obtained from each optical signal monitor 40.

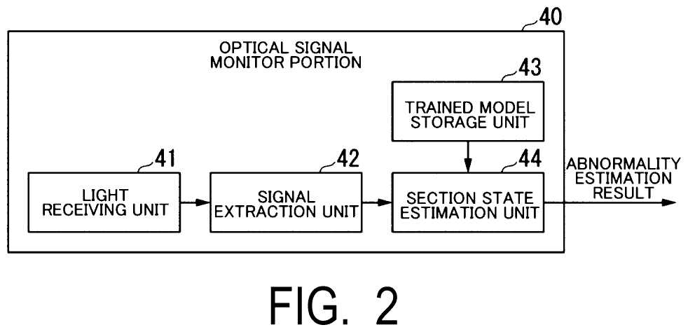

FIG. 2 is a diagram showing a configuration example of the optical signal monitor 40 in the first embodiment. The optical signal monitor 40 includes a light receiving unit 41, a signal extraction unit 42, a trained model storage unit 43, and a section state estimation unit 44. The light receiving unit 41 receives an optical signal. The signal extraction unit 42 extracts signal data from the optical signal received by the light receiving unit 41.

The trained model storage unit 43 stores a trained model that is trained to receive signal data as an input and output an abnormality estimation result of at least one of a plurality of sections. The section state estimation unit 44 acquires an abnormality estimation result of the optical fiber section by inputting the signal data extracted by the signal extraction unit 42 to the trained model. Each section state estimation unit 44 estimates the state of the section from the optical transmitter 10 to any monitoring point. For example, the section state estimation unit 44 provided in the optical signal monitor 40-1 estimates the state of the section (for example, optical fiber section 1) from the optical transmitter 10 to the monitoring point where the coupler/brancher 30-1 is located. For example, the section state estimation unit 44 provided in the optical signal monitor 40-2 estimates the state of the section (for example, optical fiber section 1+optical fiber section 2) from the optical transmitter 10 to the monitoring point where the coupler/brancher 30-2 is located. For example, the section state estimation unit 44 provided in the optical signal monitor 40-3 estimates the state of the section (for example, optical fiber section 1+optical fiber section 2+optical fiber section 3) from the optical transmitter 10 to the monitoring point where the coupler/brancher 30-3 is located.

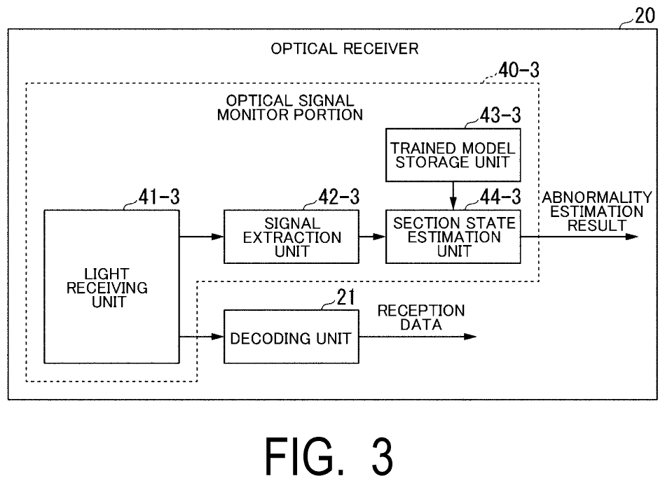

FIG. 3 is a diagram showing a configuration example of the optical receiver 20 in the first embodiment. A case where the optical signal monitor 40 is provided in the optical receiver 20 will be described. The optical signal monitor 40 (for example, optical signal monitor 40-3) provided in the optical receiver 20 generally operates by branching from the optical signal used for data communication. The optical receiver 20 includes a decoding unit 21 and an optical signal monitor 40-3. A light receiving unit 41-3 in the optical signal monitor 40-3 receives the optical signal. Of the received optical signals, the light receiving unit 41-3 outputs a main signal to the decoding unit 21, and outputs an optical signal for monitoring to a signal extraction unit 42-3.

Operations of the signal extraction unit 42-3, a trained model storage unit 43-3, and a section state estimation unit 44-3 are the same as the functional units with the same names shown in FIG. 2, and therefore a description thereof will be omitted. The decoding unit 21 restores the original main signal by performing digital signal processing on the input optical signal.

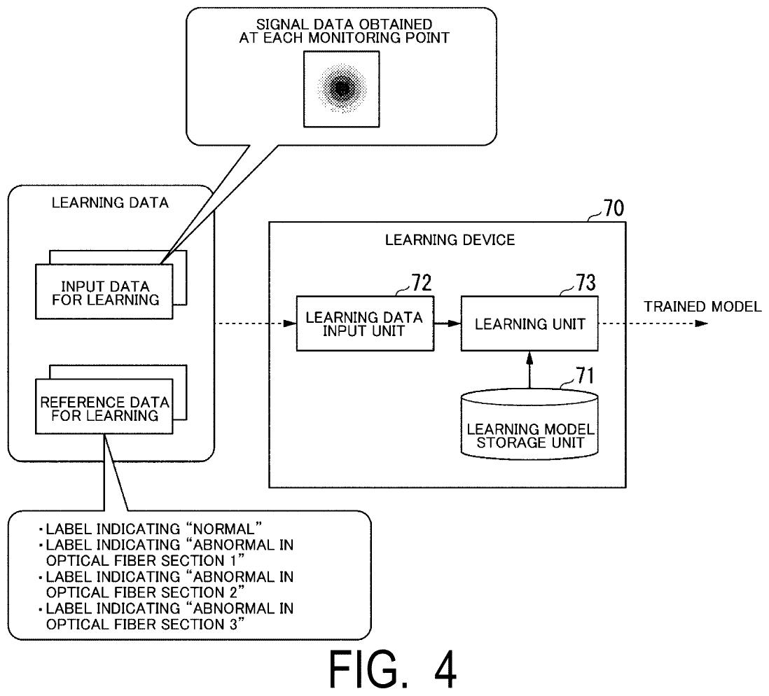

FIG. 4 is a diagram showing a configuration example of a learning device 70 in the first embodiment. The learning device 70 includes a learning model storage unit 71, a learning data input unit 72, and a learning unit 73. The learning model storage unit 71 is configured using a storage device such as a magnetic storage device or a semiconductor storage device. The learning model storage unit 71 stores a model for machine learning (hereinafter referred to as “machine learning model”) in advance. A machine learning model is represented by, for example, a neural network. A neural network is a circuit such as an electronic circuit, an electrical circuit, an optical circuit, or an integrated circuit, and is a circuit that expresses a machine learning model. The parameters of the neural network are suitably adjusted based on the loss, and the parameters of the network are the parameters of the machine learning model to be represented. The parameters of the network are the parameters of the circuits that configure the network.

The learning data input unit 72 has a function of inputting learning data. The learning data includes input data for learning and reference data for learning. The input data for learning is data to be trained. For example, the input data for learning is signal data (constellation) extracted based on an optical signal obtained at a monitoring point.

The reference data for learning is so-called correct data in machine learning. The reference data for learning is obtained by digitizing information corresponding to a class label indicating whether it is normal or abnormal. The reference data for learning is obtained by digitizing information corresponding to a class label indicating, for example, normal, abnormal in optical fiber section 1, abnormal in optical fiber section 2, and abnormal in optical fiber section 3. Hereinafter, data including a pair of at least one piece of input data for learning and one piece of reference data for learning will be referred to as learning data.

The learning unit 73 generates a trained model by learning learning data output from the learning data input unit 72 based on a machine learning model. The learning unit 73 generates a trained model by updating a predetermined machine learning model by machine learning until a predetermined termination condition is satisfied. Updating a machine learning model by machine learning means suitably adjusting the values of weight parameters in the machine learning model. In the following description, learning to be A means that the value of a parameter in the machine learning model is adjusted to satisfy A. A represents a condition. The machine learning model updated by the learning unit 73 is a machine learning model that identifies input data.

The learning device 70 may be provided in each optical signal monitor 40 or may be an external device. When the learning device 70 is an external device, each optical signal monitor 40 may transfer the signal data to the external device and acquire the trained model from the external device. Note that in the first embodiment, since a different trained model is used for each optical signal monitor 40, the optical signal monitor 40 preferably transfers signal data to a different learning device 70 to acquire a different trained model.

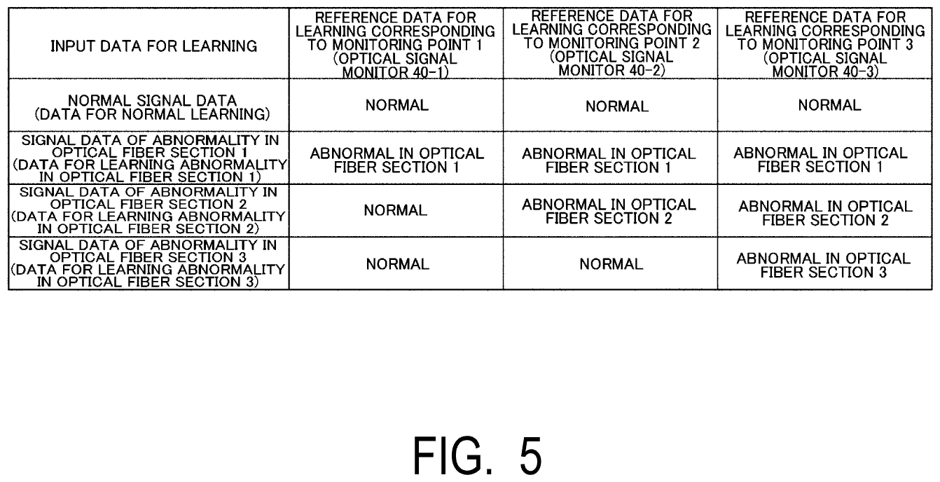

Next, processing of the learning device 70 in the first embodiment will be described in detail. FIG. 5 is a diagram for describing the processing of the learning device 70 in the first embodiment. Here, a description will be given assuming that the learning device 70 is provided in each optical signal monitor 40. Note that when the learning device 70 is provided in each optical signal monitor 40, each optical signal monitor 40 has a learning mode and an estimation mode. The learning mode is a mode in which learning is performed in the learning device 70. The estimation mode is a mode in which an abnormality in a section is estimated using a trained model generated by learning through the learning device 70.

When each optical signal monitor 40 is in the learning mode, the signal data extracted by the signal extraction unit 42 is not input to the section state estimation unit 44 but is input to the learning device 70. Thereby, the learning device 70 can perform learning using actual data. Note that even when the learning device 70 is not provided in each optical signal monitor 40 (for example, the learning device 70 is provided in an external device), each optical signal monitor 40 may have the learning mode and the estimation mode. FIG. 5 shows the relationship between input data for learning and reference data for learning for generating trained models used by each of the optical signal monitors 40-1 to 40-3.

As shown in FIG. 1, when the optical transmission line 60 is classified into three sections, there are a total of four types of states: a normal state, a state where an abnormality has occurred in the optical fiber section 1, a state where an abnormality has occurred in the optical fiber section 2, and a state where an abnormality has occurred in the optical fiber section 3. Therefore, it is necessary to prepare input data for learning corresponding to the four states. The input data for learning corresponding to the four states are, as shown in the first column of FIG. 5, signal data obtained when the optical transmission line 60 between the optical transmitter 10 and the optical receiver 20 is in a normal state (hereinafter referred to as “data for normal learning”), signal data obtained when an abnormality has occurred in the optical fiber section 1 (hereinafter referred to as “data for learning abnormality in optical fiber section 1”), signal data obtained when an abnormality has occurred in the optical fiber section 2 (hereinafter referred to as “data for learning abnormality in optical fiber section 2”), and signal data obtained when an abnormality has occurred in the optical fiber section 3 (hereinafter referred to as “data for learning abnormality in optical fiber section 3”).

Each optical signal monitor 40 performs learning by setting reference data for learning corresponding to the state observed at each monitoring point. For example, the optical signal monitor 40-1 does not observe any abnormal state in the optical fiber section 2 or the optical fiber section 3. Therefore, the learning device 70 provided in the optical signal monitor 40-1 performs learning by regarding the input data for learning indicating an abnormality in the optical fiber section 2 or the optical fiber section 3 as normal data. For example, the learning device 70 provided in the optical signal monitor 40-1 performs learning by associating reference data for learning indicating “normal” with each of the data for normal learning, the data for learning abnormality in optical fiber section 2, and the data for learning abnormality in optical fiber section 3. On the other hand, the learning device 70 provided in the optical signal monitor 40-1 performs learning by regarding the data for learning abnormality in optical fiber section 1 as abnormal data in optical fiber section 1. For example, the learning device 70 provided in the optical signal monitor 40-1 performs learning by associating reference data for learning indicating “abnormal in optical fiber section 1” with the data for learning abnormality in optical fiber section 1.

Similarly, the optical signal monitor 40-2 does not observe any abnormal state in the optical fiber section 3. Therefore, the learning device 70 provided in the optical signal monitor 40-2 performs learning by regarding the input data for learning indicating an abnormality in the optical fiber section 3 as normal data. For example, the learning device 70 provided in the optical signal monitor 40-2 performs learning by associating reference data for learning indicating “normal” with each of the data for normal learning and the data for learning abnormality in optical fiber section 3.

On the other hand, the learning device 70 provided in the optical signal monitor 40-2 performs learning by regarding the data for learning abnormality in optical fiber section 1 as abnormal data in optical fiber section 1. For example, the learning device 70 provided in the optical signal monitor 40-2 performs learning by associating reference data for learning indicating “abnormal in optical fiber section 1” with the data for learning abnormality in optical fiber section 1. Furthermore, the learning device 70 provided in the optical signal monitor 40-2 performs learning by regarding the data for learning abnormality in optical fiber section 2 as abnormal data in optical fiber section 2. For example, the learning device 70 provided in the optical signal monitor 40-2 performs learning by associating reference data for learning indicating “abnormal in optical fiber section 2” with the data for learning abnormality in optical fiber section 2.

Similarly, the optical signal monitor 40-3 can observe abnormal states in all sections. Therefore, the learning device 70 provided in the optical signal monitor 40-3 performs learning by regarding the data for normal learning as normal data. For example, the learning device 70 provided in the optical signal monitor 40-3 performs learning by associating reference data for learning indicating “normal” with the data for normal learning. On the other hand, the learning device 70 provided in the optical signal monitor 40-3 performs learning by regarding the data for learning abnormality in optical fiber section 1 as abnormal data in optical fiber section 1. For example, the learning device 70 provided in the optical signal monitor 40-3 performs learning by associating reference data for learning indicating “abnormal in optical fiber section 1” with the data for learning abnormality in optical fiber section 1.

Furthermore, the learning device 70 provided in the optical signal monitor 40-3 performs learning by regarding the data for learning abnormality in optical fiber section 2 as abnormal data in optical fiber section 2. For example, the learning device 70 provided in the optical signal monitor 40-3 performs learning by associating reference data for learning indicating “abnormal in optical fiber section 2” with the data for learning abnormality in optical fiber section 2. Furthermore, the learning device 70 provided in the optical signal monitor 40-3 performs learning by regarding the data for learning abnormality in optical fiber section 3 as abnormal data in optical fiber section 3. For example, the learning device 70 provided in the optical signal monitor 40-3 performs learning by associating reference data for learning indicating “abnormal in optical fiber section 3” with the data for learning abnormality in optical fiber section 3.

Thus, even for the same input data for learning, learning is performed by changing the reference data for learning according to the monitor position monitored by the optical signal monitor 40. In addition, it should be noted that the number of identifiable states also differs depending on the monitor position monitored by the optical signal monitor 40. For example, the optical signal monitor 40-3 can identify all four states, but the optical signal monitor 40-1 can only identify two states: normal and abnormal in optical fiber section 1.

The trained model generated through the above processing is stored in each optical signal monitor 40. In this way, each optical signal monitor 40 estimates an abnormality in a section using a different trained model. Each of the optical signal monitors 40-1, 40-2, and 40-3 transmits estimation results obtained based on the optical signals received at each monitoring point to the abnormal section estimation device 50. The abnormality estimation results output by each of the optical signal monitors 40-1, 40-2, and 40-3 include values of an output layer in addition to the estimation results.

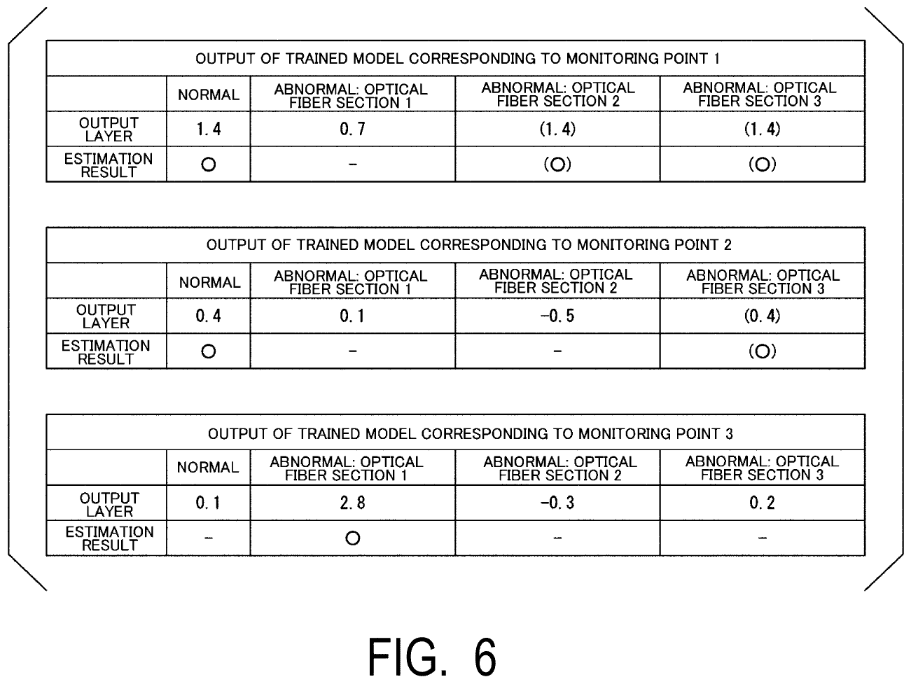

Next, a method for the abnormal section estimation device 50 to estimate an abnormal section based on the abnormality estimation results obtained from each optical signal monitor 40 will be described. FIG. 6 is a diagram for describing an abnormal section estimation method performed by the abnormal section estimation device 50. FIG. 6 shows the values of the output layer of each of the optical signal monitors 40-1 to 40-3 and the estimation results based on the values. The upper part of FIG. 6 shows the values of the output layer output from the trained model (for example, the trained model stored in the optical signal monitor 40-1) corresponding to the monitoring point 1 and the estimation results based thereon. The middle part of FIG. 6 shows the values of the output layer output from the trained model (for example, the trained model stored in the optical signal monitor 40-2) corresponding to the monitoring point 2 and the estimation results based thereon. The lower part of FIG. 6 shows the values of the output layer output from the trained model (for example, the trained model stored in the optical signal monitor 40-3) corresponding to the monitoring point 3 and the estimation results based thereon.

Generally, in estimation using a single neural network, the largest positive or negative value output for each label in the output layer of the neural network is employed as the estimation result. For example, in the trained model corresponding to the monitoring point 3, the abnormality in the optical fiber section 1 with the largest value of output layer is output as the estimation result of the trained model corresponding to the monitoring point 3. Although the optical signal monitor 40-1 or 40-2 has state abnormalities that cannot be identified as described above, it is assumed here that these state abnormalities occur to the same extent as the “normal” state. For example, in FIG. 6, the estimation result of the optical signal monitor 40-1 is “normal,” it is assumed that there is a similar likelihood that an abnormality has occurred in the optical fiber section 2 or the optical fiber section 3, and these are also taken into account as the estimation result.

As a first estimation method for estimating an abnormal section in the abnormal section estimation unit 51 of the abnormal section estimation device 50, there is a method in which the estimation result is determined by majority decision. In the first estimation method, the abnormal section estimation unit 51 sets the state with the largest number of labels as the overall estimation result among the estimation results obtained from all the optical signal monitors 40-1 to 40-3. In the example of FIG. 6, the estimation result is normal or abnormal in optical fiber section 3. Alternatively, when it is necessary to uniquely estimate the state, it can be considered that the state cannot be estimated.

As a second estimation method, there is a determination method using the value of the output layer. The abnormal section estimation unit 51 collects the values of the output layer from each optical signal monitor 40 and calculates the sum for each label. The label with the largest value is used as the estimation result. In the example of FIG. 6, the values obtained by summing the labels of normal, abnormal in optical fiber section 1, abnormal in optical fiber section 2, and abnormal in optical fiber section 3 at each optical signal monitor 40 are 1.9, 3.6, 0.6, and 2.0, respectively. Therefore, the abnormal section estimation unit 51 uses the abnormal in optical fiber section 1 with the largest value as the estimation result.

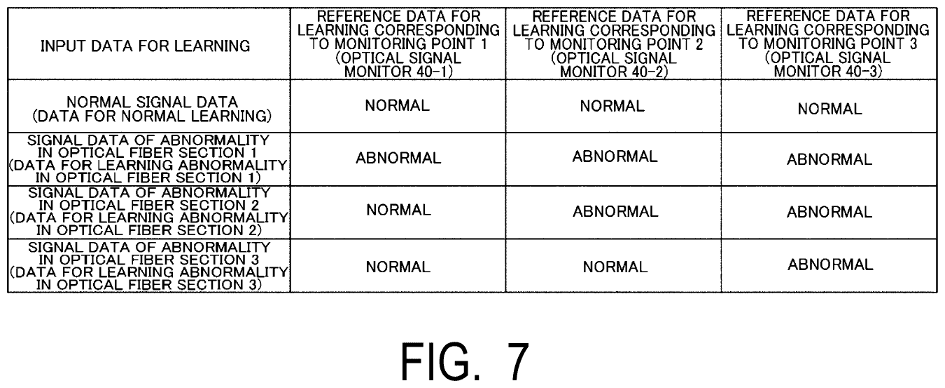

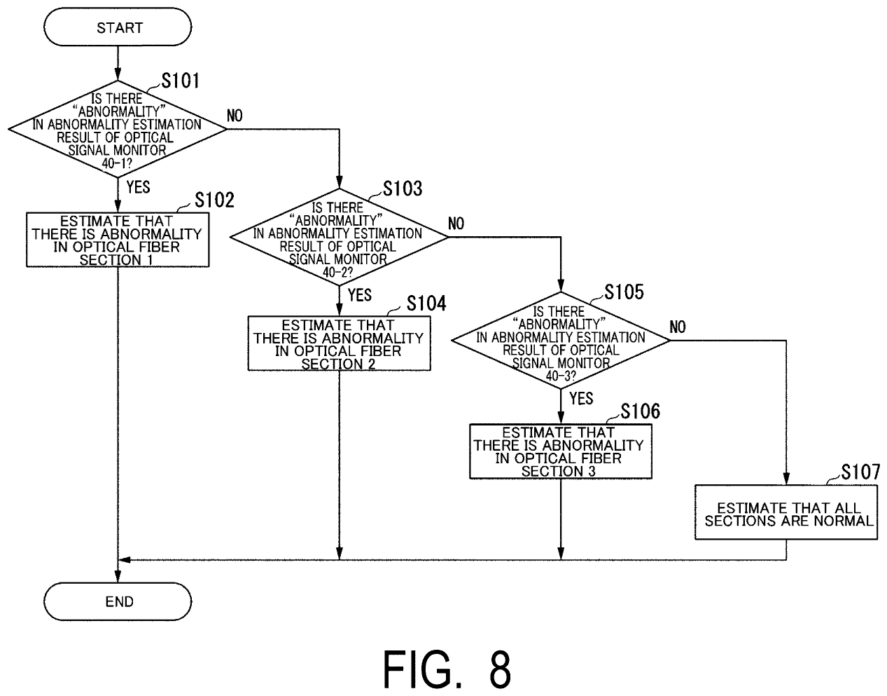

As a third estimation method, there is a determination method for estimating an abnormality occurrence section by sequentially determining the presence or absence of an abnormality in a specific section based on the estimation results. The third estimation method will be described with reference to FIGS. 7 and 8. FIG. 7 is a diagram for describing the third estimation method performed by the abnormal section estimation unit 51 in the first embodiment. The third estimation method is a method in which each optical signal monitor 40 does not estimate the section in which the abnormality has occurred as shown in FIG. 6, and each optical signal monitor 40 regards all states other than normal to be abnormal without identifying the abnormality occurrence section, and identifies only two states, normal and abnormal as shown in FIG. 7.

When performing the third estimation method, the learning method by the learning device 70 is different from the learning method using FIG. 5. This point will be described. In the learning method using FIG. 5, as reference data for learning, it is necessary to use four pieces of reference data for learning indicating “normal,” “abnormal in optical fiber section 1,” “abnormal in optical fiber section 2,” and “abnormal in optical fiber section 3.” On the other hand, in the learning method by the learning device 70 when performing the third estimation method, two pieces of reference data for learning indicating “normal” or “abnormal” are used as the reference data for learning.

For example, the learning device 70 provided in the optical signal monitor 40-1 performs learning by associating reference data for learning indicating “normal” with each of the data for normal learning, the data for learning abnormality in optical fiber section 2, and the data for learning abnormality in optical fiber section 3. On the other hand, the learning device 70 provided in the optical signal monitor 40-1 performs learning by regarding the data for learning abnormality in optical fiber section 1 as abnormal data. For example, the learning device 70 provided in the optical signal monitor 40-1 performs learning by associating reference data for learning indicating “abnormal” with the data for learning abnormality in optical fiber section 1.

Similarly, the learning device 70 provided in the optical signal monitor 40-2 performs learning by regarding the input data for learning indicating an abnormality in the optical fiber section 3 as normal data. For example, the learning device 70 provided in the optical signal monitor 40-2 performs learning by associating reference data for learning indicating “normal” with each of the data for normal learning and the data for learning abnormality in optical fiber section 3.

On the other hand, the learning device 70 provided in the optical signal monitor 40-2 performs learning by regarding the data for learning abnormality in optical fiber section 1 and the data for learning abnormality in optical fiber section 2 as abnormal data. For example, the learning device 70 provided in the optical signal monitor 40-2 performs learning by associating reference data for learning indicating “abnormal” with the data for learning abnormality in optical fiber section 1 and the data for learning abnormality in optical fiber section 2.

Similarly, the learning device 70 provided in the optical signal monitor 40-3 performs learning by regarding the data for normal learning as normal data. For example, the learning device 70 provided in the optical signal monitor 40-3 performs learning by associating reference data for learning indicating “normal” with the data for normal learning. On the other hand, the learning device 70 provided in the optical signal monitor 40-3 performs learning by regarding the data for learning abnormality in optical fiber section 1, the data for learning abnormality in optical fiber section 2, and the data for learning abnormality in optical fiber section 3 as abnormal data. For example, the learning device 70 provided in the optical signal monitor 40-3 performs learning by associating reference data for learning indicating “abnormal” with data for learning abnormality in optical fiber section 1, the data for learning abnormality in optical fiber section 2, and the data for learning abnormality in optical fiber section 3.

In this way, when performing the third estimation method, a trained model is generated so that the estimation result outputs one of the two states of “normal” and “abnormal.” When the values to be identified are limited to only two values, although the label granularity becomes coarser than in a trained model that estimates three or more values, and the estimation accuracy decreases, it becomes easier to train the machine learning model. Each optical signal monitor 40 outputs an abnormality estimation result including an estimation result indicating either “normal” or “abnormal.”

The abnormal section estimation unit 51 determines whether or not there is an abnormality in the optical fiber section 1 based on the abnormality estimation result output from the optical signal monitor 40-1. When the abnormality estimation result output from the optical signal monitor 40-1 includes “abnormal” as the estimation result, the abnormal section estimation unit 51 estimates that there is an abnormality in the optical fiber section 1. On the other hand, when the abnormality estimation result output from the optical signal monitor 40-1 includes “normal” as the estimation result, the abnormal section estimation unit 51 executes similar processing based on the abnormality estimation result of the optical signal monitor 40-2. Only when the abnormality estimation results of all the optical signal monitors 40 are estimated to be normal, the abnormal section estimation unit 51 determines that the section between the optical transmitter 10 and the optical receiver 20 is normal. Note that this method can be similarly applied to a case where there are four or more sections.

FIG. 8 is a flowchart showing a flow of processing of the third estimation method performed by the abnormal section estimation device 50 according to the first embodiment. The abnormal section estimation unit 51 of the abnormal section estimation device 50 determines whether or not an abnormality is indicated by the abnormality estimation result obtained from the optical signal monitor 40-1 (step S101). When the abnormality estimation result obtained from the optical signal monitor 40-1 indicates an abnormality (step S101-YES), the abnormal section estimation unit 51 estimates that there is an abnormality in the optical fiber section 1. On the other hand, when the abnormality estimation result obtained from the optical signal monitor 40-1 does not indicate an abnormality (it is “normal”) (step S101-NO), the abnormal section estimation unit 51 determines whether or not an abnormality is indicated by the abnormality estimation result obtained from the optical signal monitor 40-2 (step S103).

When the abnormality estimation result obtained from the optical signal monitor 40-2 indicates an abnormality (step S103-YES), the abnormal section estimation unit 51 estimates that there is an abnormality in the optical fiber section 2 (step S104). On the other hand, when the abnormality estimation result obtained from the optical signal monitor 40-2 does not indicate an abnormality (it is “normal”) (step S103-NO), the abnormal section estimation unit 51 determines whether or not an abnormality is indicated by the abnormality estimation result obtained from the optical signal monitor 40-3 (step S105).

When the abnormality estimation result obtained from the optical signal monitor 40-3 indicates an abnormality (step S105-YES), the abnormal section estimation unit 51 estimates that there is an abnormality in the optical fiber section 3 (step S106). On the other hand, when the abnormality estimation result obtained from the optical signal monitor 40-3 does not indicate an abnormality (it is “normal”) (step S105-NO), the abnormal section estimation unit 51 estimates that all sections are normal (step S107).

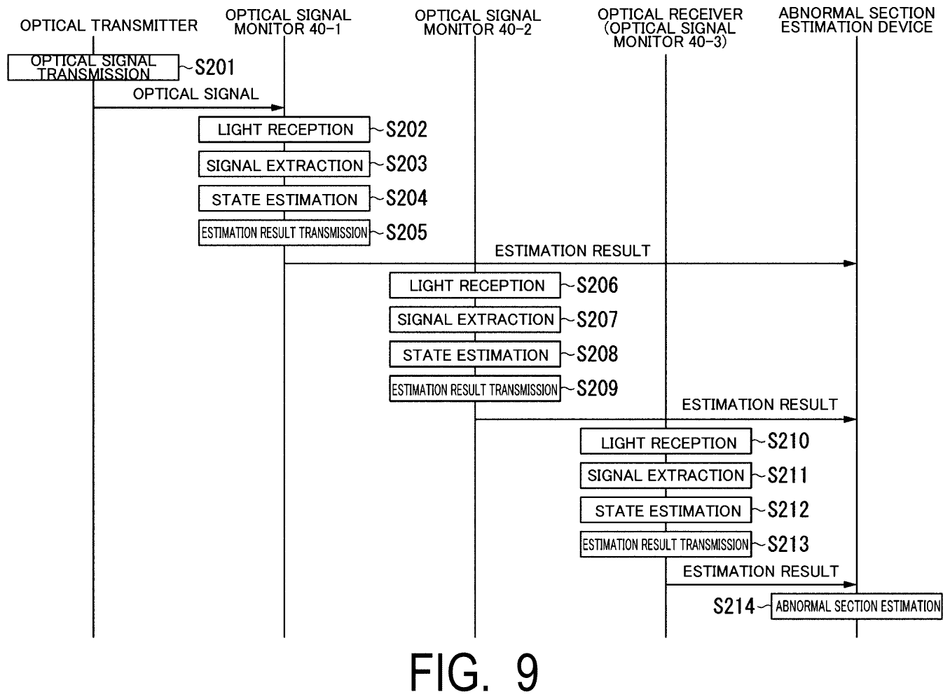

FIG. 9 is a sequence diagram showing a flow of processing of the abnormal section estimation system 100 according to the first embodiment. In the description of FIG. 9, it is assumed that each optical signal monitor 40 stores a trained model.

The optical transmitter 10 transmits an optical signal (step S201). The optical signal transmitted from the optical transmitter 10 propagates through the optical transmission line 60 and is input to the coupler/brancher 30-1. The optical signal input to the coupler/brancher 30-1 is branched into two paths. The optical signal branched by the coupler/brancher 30-1 is input to the optical signal monitor 40-1 and the coupler/brancher 30-2.

The light receiving unit 41-1 of the optical signal monitor 40-1 receives the optical signal branched by the coupler/brancher 30-1 (step S202). The signal extraction unit 42-1 extracts signal data from the optical signal received by the light receiving unit 41-1 (step S203). The signal extraction unit 42-1 outputs the extracted signal data to the section state estimation unit 44-1. The section state estimation unit 44-1 inputs the signal data output from the signal extraction unit 42-1 into the trained model stored in the trained model storage unit 43-1 to acquire an estimation result (step S204). The section state estimation unit 44-1 outputs the acquired estimation result to the abnormal section estimation device 50 (step S205).

The optical signal input to the coupler/brancher 30-2 is branched into two paths. The optical signal branched by the coupler/brancher 30-2 is input to the optical signal monitor 40-2 and the optical receiver 20. The light receiving unit 41-2 of the optical signal monitor 40-2 receives the optical signal branched by the coupler/brancher 30-2 (step S206). The signal extraction unit 42-2 extracts signal data from the optical signal received by the light receiving unit 41-2 (step S207). The signal extraction unit 42-2 outputs the extracted signal data to the section state estimation unit 44-2. The section state estimation unit 44-2 inputs the signal data output from the signal extraction unit 42-2 into the trained model stored in the trained model storage unit 43-2 to acquire an estimation result (step S208). The section state estimation unit 44-2 outputs the acquired estimation result to the abnormal section estimation device 50 (step S209).

The optical signal input to the optical receiver 20 is received by the light receiving unit 41-3 of the optical signal monitor 40-3 (step S210). The signal extraction unit 42-3 extracts signal data from the optical signal received by the light receiving unit 41-3 (step S211). The signal extraction unit 42-3 outputs the extracted signal data to the section state estimation unit 44-3. The section state estimation unit 44-3 inputs the signal data output from the signal extraction unit 42-3 into the trained model stored in the trained model storage unit 43-3 to acquire an estimation result (step S212). The section state estimation unit 44-3 outputs the acquired estimation result to the abnormal section estimation device 50 (step S213).

The abnormal section estimation unit 51 of the abnormal section estimation device 50 estimates an abnormal section based on the estimation results output from each optical signal monitor 40 (step S214). Specifically, the abnormal section estimation unit 51 estimates the abnormal section using the first estimation method, the second estimation method, and the third estimation method.

According to the abnormal section estimation system 100 configured as described above, the optical transmission line 60 is divided into a plurality of sections at one or more monitoring points from the optical transmitter 10 to the optical receiver 20, signal data is extracted at the one or more monitoring points based on an optical signal transmitted from the optical transmitter 10, an abnormality estimation result of at least one of the plurality of sections is acquired by inputting the signal data extracted at the one or more monitoring points to trained models that are trained to receive the signal data as an input and output the abnormality estimation result, and a section in which an abnormality has occurred is estimated based on the acquired abnormality estimation result. In this way, by applying machine learning to each piece of the signal data acquired from the optical signal monitors 40 provided at a plurality of points on the optical transmission line 60, there is no need for decoding by digital signal processing at the relay monitoring point, and therefore the calculation load can be suppressed. Furthermore, by integrating the abnormality estimation results obtained at each monitoring point, it is possible to estimate the section in which an abnormality has occurred in the optical transmission line 60 with high accuracy. Therefore, it becomes possible to estimate the section where the abnormality has occurred with high accuracy while suppressing the calculation load.

Furthermore, in the abnormal section estimation system 100, using the estimation results at each monitoring point obtained by inputting the signal data acquired from each optical signal monitor 40 into the trained model corresponding to each monitoring point and the values of the output layer, the section with the largest value of the output layer is estimated as the section in which the abnormality has occurred. With this, it is possible to estimate an abnormal section by taking into account the results obtained at a plurality of monitoring points. Therefore, it becomes possible to improve the estimation accuracy of the abnormal section.

Furthermore, in the abnormal section estimation system 100, the section with the largest number of sections indicated by the estimation results at each monitoring point obtained by inputting the signal data acquired from each optical signal monitor 40 into the trained model corresponding to each monitoring point is estimated as the section in which the abnormality has occurred. With this, it is possible to estimate an abnormal section by taking into account the results obtained at a plurality of monitoring points. Therefore, it becomes possible to improve the estimation accuracy of the abnormal section.

Furthermore, in the abnormal section estimation system 100, the presence or absence of an abnormality in a specific section is sequentially determined from the estimation results at each monitoring point obtained by inputting the signal data acquired from each optical signal monitor 40 into the trained model corresponding to each monitoring point, and a section in which it is determined that there is an abnormality is estimated as the section in which the abnormality has occurred. Thereby, it becomes possible to suppress the calculation load.

### Second Embodiment

In the first embodiment, a configuration has been shown in which estimation results are acquired using a trained model in each optical signal monitor. In a second embodiment, a configuration will be described in which an abnormal section estimation device acquires signal data from each optical signal monitor and estimates an abnormal section.

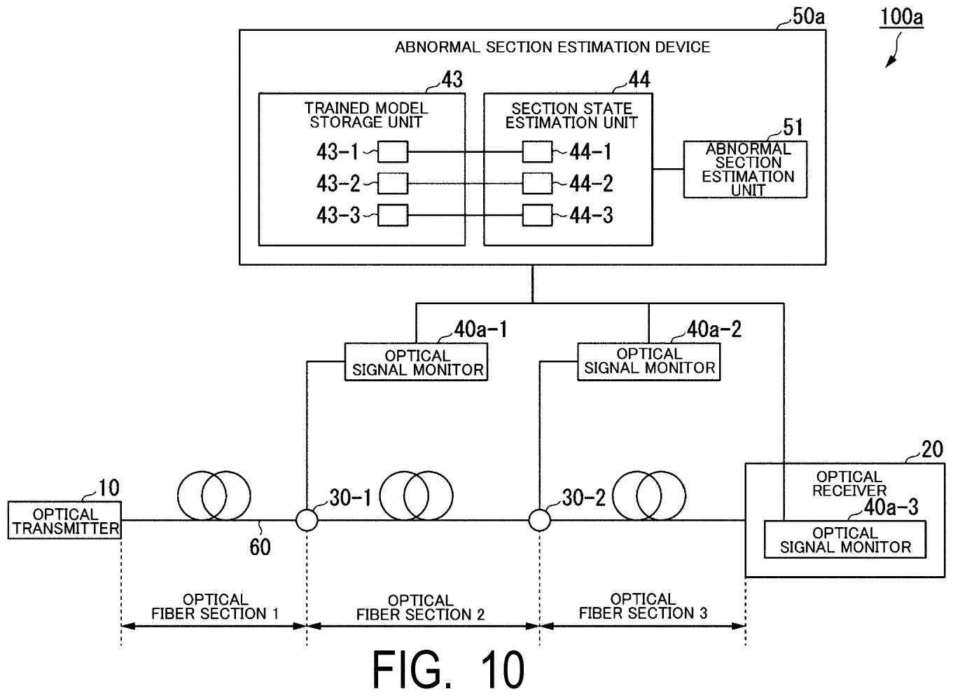

FIG. 10 is a diagram showing a configuration example of an abnormal section estimation system 100a according to the second embodiment. The abnormal section estimation system 100a includes an optical transmitter 10, an optical receiver 20, one or more couplers/branchers 30, a plurality of optical signal monitors 40a, and an abnormal section estimation device 50a. The abnormal section estimation system 100a differs in configuration from the abnormal section estimation system 100 in that it includes an optical signal monitor 40a and an abnormal section estimation device 50a instead of the optical signal monitor 40 and the abnormal section estimation device 50. The rest of the configuration of the abnormal section estimation system 100a is the same as that of the abnormal section estimation system 100. The optical signal monitor 40a and the abnormal section estimation device 50a will be described below.

The optical signal monitor 40a receives, as an input, the optical signal branched by the coupler/brancher 30 or the optical signal propagated through the optical transmission line 60. The optical signal monitor 40a extracts signal data using the input optical signal. The optical signal monitor 40a outputs the extracted signal data to the abnormal section estimation device 50a. In this way, the optical signal monitor 40a does not perform estimation using a trained model. That is, the optical signal monitor 40a does not include the trained model storage unit 43 and the section state estimation unit 44.

The abnormal section estimation device 50a includes a trained model storage unit 43, a section state estimation unit 44, and an abnormal section estimation unit 51. The abnormal section estimation device 50a differs in configuration from the abnormal section estimation device 50 in that it newly includes the trained model storage unit 43 and the section state estimation unit 44. The rest of the configuration of the abnormal section estimation device 50a is the same as that of the abnormal section estimation device 50. The trained model storage unit 43 and the section state estimation unit 44 will be described below.

The trained model storage unit 43 includes trained model storage units 43-1, 43-2, and 43-3. The trained model storage units 43-1, 43-2, and 43-3 are the same as the functional units with the same names in the first embodiment. In the second embodiment, the learning device 70 may be provided in the abnormal section estimation device 50a, or may be provided in the abnormal section estimation system 100a as an external device. Note that when the learning device 70 is provided in the abnormal section estimation device 50a, the abnormal section estimation device 50a has a learning mode and an estimation mode. Even when the learning device 70 is not provided in the abnormal section estimation device 50a (for example, the learning device 70 is provided in an external device), the abnormal section estimation device 50a may have the learning mode and the estimation mode.

The section state estimation unit 44 includes section state estimation units 44-1, 44-2, and 44-3. The section state estimation units 44-1, 44-2, and 44-3 perform the same processing as the functional units with the same names in the first embodiment.

According to the abnormal section estimation system 100a configured as described above, effects similar to those of the first embodiment can be obtained. Furthermore, in the abnormal section estimation system 100a, the abnormal section estimation device 50a includes the trained model storage unit 43 and section state estimation unit 44 that each optical signal monitor 40 was provided with in the first embodiment. Thereby, the abnormal section estimation device 50a does not need to perform estimation using a trained model in each optical signal monitor 40a. That is, each optical signal monitor 40a only needs to extract signal data from the optical signal and transmit the extracted signal data to the abnormal section estimation device 50a. Therefore, the functions provided in each optical signal monitor 40a can be reduced.

### Third Embodiment

In a third embodiment, a configuration will be described in which signal data acquired from each optical signal monitor is used to perform learning of a single machine learning model and estimation using a single trained model.

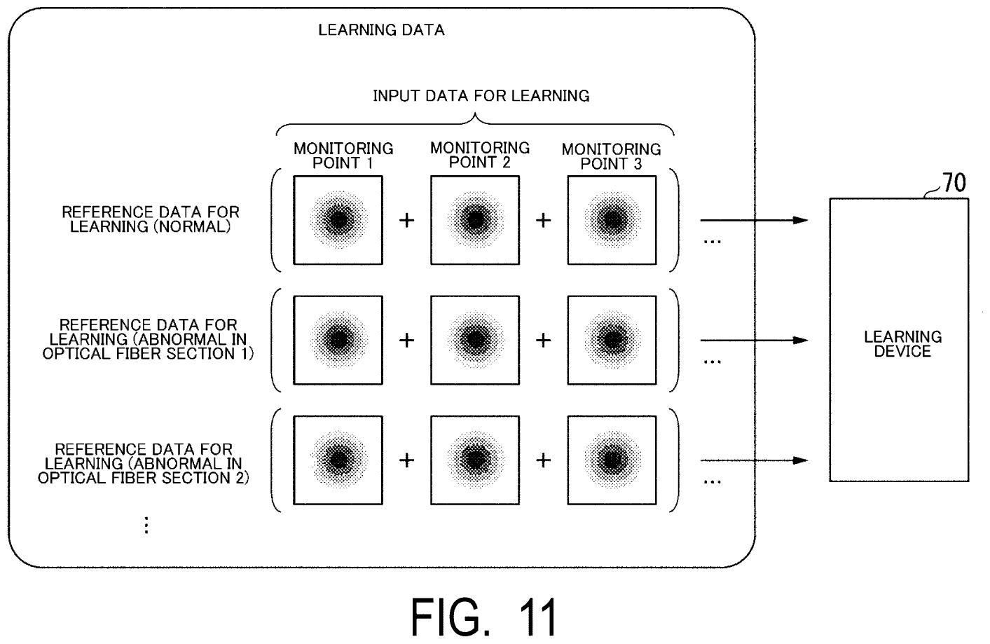

FIG. 11 is a diagram for describing a learning method of a machine learning model in the third embodiment. As shown in FIG. 11, in the third embodiment, machine learning is performed by inputting data with the same label acquired from each monitoring point to the learning device 70 as one piece of learning data. For example, signal data indicating a normal state acquired at the monitoring point 1, signal data indicating a normal state acquired at the monitoring point 2, and signal data indicating a normal state acquired at the monitoring point 3 are used as one piece of input data for learning and input into a machine learning model as one piece of learning data together with the reference data for learning “normal,” and the machine learning model is updated by machine learning.

Similarly, signal data indicating that an abnormality has occurred in the optical fiber section 1 acquired at the monitoring point 1, signal data indicating that an abnormality has occurred in the optical fiber section 1 acquired at the monitoring point 2, and signal data indicating that an abnormality has occurred in the optical fiber section 1 acquired at the monitoring point 3 are used as one piece of input data for learning and input into a machine learning model as one piece of learning data together with the reference data for learning “abnormal in optical fiber section 1,” and the machine learning model is updated by machine learning.

Similarly, signal data indicating that an abnormality has occurred in the optical fiber section 2 acquired at the monitoring point 1, signal data indicating that an abnormality has occurred in the optical fiber section 2 acquired at the monitoring point 2, and signal data indicating that an abnormality has occurred in the optical fiber section 2 acquired at the monitoring point 3 are used as one piece of input data for learning and input into a machine learning model as one piece of learning data together with the reference data for learning “abnormal in optical fiber section 2,” and the machine learning model is updated by machine learning.

Similarly, signal data indicating that an abnormality has occurred in the optical fiber section 3 acquired at the monitoring point 1, signal data indicating that an abnormality has occurred in the optical fiber section 3 acquired at the monitoring point 2, and signal data indicating that an abnormality has occurred in the optical fiber section 3 acquired at the monitoring point 3 are used as one piece of input data for learning and input into a machine learning model as one piece of learning data together with the reference data for learning “abnormal in optical fiber section 3,” and the machine learning model is updated by machine learning.

Through the above-described processing, one trained model that is trained to output an abnormality estimation result of the optical fiber section according to the signal data is generated.

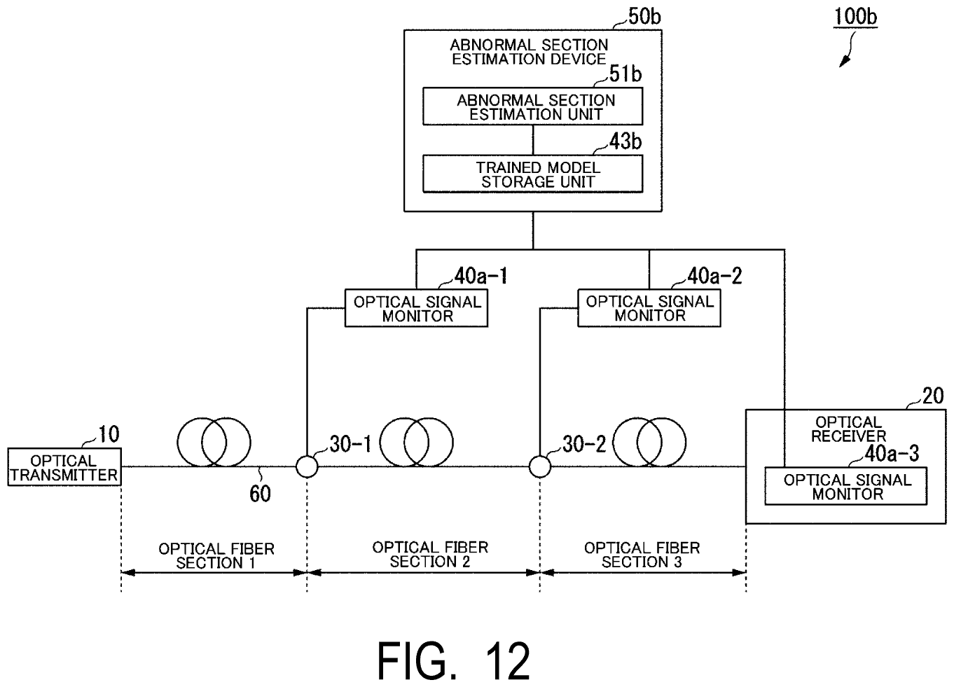

FIG. 12 is a diagram showing a configuration example of an abnormal section estimation system 100b according to the third embodiment. The abnormal section estimation system 100b includes an optical transmitter 10, an optical receiver 20, one or more couplers/branchers 30, a plurality of optical signal monitors 40a, and an abnormal section estimation device 50b. The abnormal section estimation system 100b differs in configuration from the abnormal section estimation system 100a in that it includes an abnormal section estimation device 50b instead of the abnormal section estimation device 50a. The rest of the configuration of the abnormal section estimation system 100b is the same as that of the abnormal section estimation system 100a. The abnormal section estimation device 50b will be described below.

The abnormal section estimation device 50b includes a trained model storage unit 43b and an abnormal section estimation unit 51b. One trained model is stored in the trained model storage unit 43b. In the first embodiment and the second embodiment, a trained model corresponding to each of the optical signal monitors 40 and 40a was used to estimate the abnormal section, but in the third embodiment, one trained model is used to estimate the abnormal section. One trained model stored in the trained model storage unit 43b receives, as an input, a set of signal data transmitted from each optical signal monitor 40a, and outputs an abnormality estimation result of the optical fiber section.

The abnormal section estimation unit 51b inputs the set of signal data transmitted from each optical signal monitor 40a into the trained model, and acquires the abnormality estimation result of the optical fiber section. The abnormal section estimation unit 51b estimates an abnormal section based on the acquired abnormality estimation result of the optical fiber section.

According to the abnormal section estimation system 100b configured as described above, a machine learning model is updated by machine learning using a set of input data for learning in the same state obtained at each monitoring point and reference data for learning indicating the state to generate a trained model. The abnormal section estimation unit 51b acquires an abnormality estimation result by inputting each piece of signal data extracted by each optical signal monitor 40a as one piece of signal data to the trained model, and estimates an abnormal section based on the acquired abnormality estimation result. Accordingly, the abnormal section estimation unit 51b does not need to acquire abnormality estimation results using different trained models for each piece of signal data extracted by each optical signal monitor 40a, and estimate an abnormal section based on each abnormality estimation result. Therefore, it becomes possible to reduce the processing load on the abnormal section estimation unit 51b.

### Fourth Embodiment

In a fourth embodiment, a configuration in which the present invention is applied to a system in which multiplex communication in which optical signals are multiplexed is performed will be described. Note that the multiplex communication here includes wavelength division multiplex communication, spatial multiplex communication, and the like. In the following description, a configuration in which the present invention is applied to a system in which wavelength division multiplex communication is performed will be described as an example.

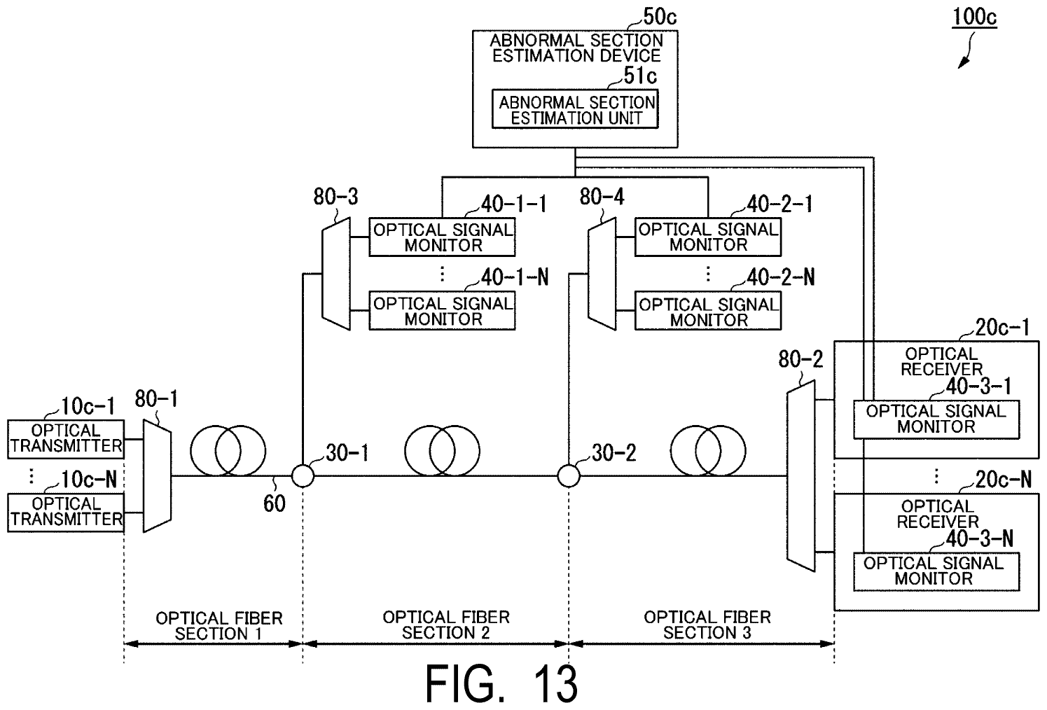

FIG. 13 is a diagram showing a configuration example of an abnormal section estimation system 100c according to the fourth embodiment. The abnormal section estimation system 100c includes a plurality of optical transmitters 10c-1 to 10c-N (N is an integer of 2 or more), aa plurality of optical receivers 20c-1 to 20c-N, couplers/branchers 30-1 and 30-2, a plurality of optical signal monitors 40-1-1 to 40-1-N, 40-2-1 to 40-2-N, and 40-3-1 to 40-3-N, an abnormal section estimation device 50c, and a plurality of optical multiplexers/demultiplexers 80-1 to 80-4. Hereinafter, the differences from the abnormal section estimation system 100 will be described.

The plurality of optical transmitters 10c-1 to 10c-N transmit optical signals of different wavelengths λ₁ to λ_{N}.

The plurality of optical receivers 20c-1 to 20c-N receive optical signals transmitted from the plurality of optical transmitters 10c-1 to 10c-N. The plurality of optical receivers 20c-1 to 20c-N include different optical signal monitors 40-3-1 to 40-3-N. For example, the optical receiver 20c-1 includes the optical signal monitor 40-3-1.

Each optical signal monitor 40 receives, as an input, the optical signal branched by the coupler/brancher 30 or the optical signal propagated through the optical transmission line 60. At each monitoring point, optical signal monitors 40 may be provided for the number of wavelengths. That is, an optical signal of one wavelength is input to each optical signal monitor 40. The processing performed by each optical signal monitor 40 is similar to that in the first embodiment. Each optical signal monitor 40 has the configuration shown in FIG. 2.

The optical multiplexers/demultiplexers 80-1 to 80-4 multiplex or demultiplex optical signals. For example, the optical multiplexer/demultiplexer 80-1 multiplexes the optical signals transmitted from each optical transmitter 10c to generate a multiplexed signal, and outputs the generated multiplexed signal to the optical transmission line 60. For example, multiplexed signals are input to the optical multiplexers/demultiplexers 80-2 to 80-4. The optical multiplexers/demultiplexers 80-2 to 80-4 demultiplex the input multiplexed signal for each wavelength.

The abnormal section estimation device 50c includes an abnormal section estimation unit 51c. The abnormal section estimation unit 51c estimates the section in which the abnormality has occurred based on the abnormality estimation results of the optical fiber sections obtained from each optical signal monitor 40. The abnormal section estimation unit 51c estimates the state at each wavelength based on the abnormality estimation results of the optical fiber sections obtained from each optical signal monitor 40, and then integrates the estimation results for each wavelength and estimates the presence or absence of an abnormality occurrence and the section.

The abnormal section estimation system 100c configured as described above can also be applied to a system that performs multiplex communication.

### Modification Example 1 in Fourth Embodiment

When spatial multiplex communication is used as multiplex communication, the abnormal section estimation system 100c includes fan-in and fan-out equipment instead of the optical multiplexers/demultiplexers 80-1 to 80-4. For example, fan-in equipment is provided instead of the optical multiplexer/demultiplexer 80-1, and fan-out equipment is provided instead of the optical multiplexers/demultiplexers 80-2 to 80-4. Accordingly, one or more estimation results can be obtained at each monitoring point, and estimation based on these results becomes possible.

### Modification Example 2 in Fourth Embodiment

In each optical signal monitor 40, the abnormal section estimation unit 51c may be configured to estimate an abnormal section based on signal data obtained from each optical signal monitor 40, as in the third embodiment. When configured in this way, the abnormal section estimation unit 51c first directly estimates the section state for each wavelength, and estimates the abnormal section from each estimation result.

### Modification Example 3 in Fourth Embodiment

In the configuration of the fourth embodiment, the trained model storage unit 43 and the section state estimation unit 44 may be provided in the abnormal section estimation device 50c as in the second embodiment. In this case, if the number of multiplexing is N, the number of trained model storage units 43 and section state estimation units 44 will each be multiplied by N times. For example, the abnormal section estimation device 50a includes trained model storage units 43-1, . . . , 43-3N and section state estimation units 44-1, . . . , 44-3N with respect to the trained model storage unit 43 and the section state estimation unit 44. Specifically, the abnormal section estimation unit 51c first estimates the section state for each wavelength using the same processing as in the second embodiment, and estimates the abnormal section from each estimation result.

Some or all of the functional units of the abnormal section estimation devices 50, 50a, 50b, and 50c described above are implemented as software by a processor such as a central processing unit (CPU) executing a program stored in a storage unit and a storage device including a non-volatile recording medium (non-transitory recording medium). The program may be recorded on a non-transitory computer-readable recording medium. The non-transitory computer-readable recording medium is, for example, a portable medium such as a flexible disk, a magneto-optical disk, a read only memory (ROM), or a compact disc read only memory (CD-ROM), or a non-transitory recording medium such as a storage device such as a hard disk built in a computer system.

Some or all of the functional units of the abnormal section estimation devices 50, 50a, 50b, and 50c described above may be implemented using hardware including an electronic circuit (electronic circuit or circuitry) in which, for example, a large scale integrated circuit (LSI), an application specific integrated circuit (ASIC), a programmable logic device (PLD), a field programmable gate array (FPGA), or the like is used.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention can be applied to a system using an optical transmission line connecting an optical transmitter and an optical receiver.

### REFERENCE SIGNS LIST

10 Optical transmitter
20 Optical receiver
21 Decoding unit
30, 30-1, 30-2 Coupler/brancher
40, 40-1, 40-2, 40-3, 40a-1, 40a-2, 40a-3 Optical signal monitor
41 Light receiving unit
42 Signal extraction unit
43, 43b Trained model storage unit
44 Section state estimation unit
50, 50a, 50b Abnormal section estimation device
51, 51b Abnormal section estimation unit
60 Optical transmission line
70 Learning device
71 Learning model storage unit
72 Learning data input unit
80, 80-1, 80-2, 80-3, 80-4 Optical multiplexer/demultiplexer
100, 100a, 100b, 100c Abnormal section estimation system

1. An abnormal section estimation method in a system in which an optical transmitter and an optical receiver are connected by an optical transmission line,
the optical transmission line being divided into a plurality of sections at one or more monitoring points from the optical transmitter to the optical receiver, the abnormal section estimation method comprising:
extracting, based on an optical signal transmitted from the optical transmitter, signal data on a complex plane of the optical signal expressed by a phase and an amplitude at the one or more monitoring points;
acquiring an abnormality estimation result of at least one of the plurality of sections by inputting the signal data extracted at the one or more monitoring points to trained models that are trained to receive the signal data as an input and output the abnormality estimation result; and
estimating a section in which an abnormality has occurred based on the acquired abnormality estimation result.

2. The abnormal section estimation method according to claim 1, wherein
the trained models are a plurality of trained models that are associated with each monitoring point and are trained to be able to output abnormalities in sections observable at each monitoring point as an abnormality estimation result,
the abnormality estimation result includes estimation results and values of an output layer according to the estimation results, and
the abnormal section estimation method further comprises summing the values of the output layer for each of the estimation results, and estimating a section indicated by the estimation result with the largest summed value as the section in which the abnormality has occurred.

3. The abnormal section estimation method according to claim 1, wherein
the trained models are a plurality of trained models that are associated with each monitoring point and are trained to be able to output abnormalities in sections observable at each monitoring point as an abnormality estimation result,
the abnormality estimation result includes estimation results and values of an output layer according to the estimation results, and
the abnormal section estimation method further comprises estimating a section indicated by the estimation result with the largest number as the section in which the abnormality has occurred.

4. The abnormal section estimation method according to claim 1, wherein
the trained models are a plurality of trained models that are associated with each monitoring point and are trained to be able to output abnormalities in sections observable at each monitoring point as an abnormality estimation result,
the abnormality estimation result includes estimation results and values of an output layer according to the estimation results, and
the abnormal section estimation method further comprises sequentially determining the presence or absence of an abnormality in a specific section from the estimation result, and estimating a section in which it is determined that there is an abnormality as the section in which the abnormality has occurred.

5. The abnormal section estimation method according to claim 1, wherein
the trained model is trained to receive a plurality of pieces of signal data of the same state extracted at each monitoring point as one piece of signal data, and to output an abnormality estimation result of at least one of the plurality of sections, and
the abnormal section estimation method further comprises acquiring the abnormality estimation result by inputting each piece of signal data extracted at each monitoring point as one piece of signal data to the trained model.

6. The abnormal section estimation method according to claim 1, wherein the optical signal is a multiplexed optical signal.

7. An abnormal section estimation system comprising:
an optical transmitter configured to transmit an optical signal;
an optical receiver configured to receive the optical signal transmitted from the optical transmitter;
an optical transmission line configured to connect the optical transmitter and the optical receiver and divide into a plurality of sections at one or more monitoring points from the optical transmitter to the optical receiver;
one or more optical signal monitors configured to extract, based on an optical signal transmitted from the optical transmitter, signal data on a complex plane of the optical signal expressed by a phase and an amplitude at the one or more monitoring points; and
an abnormal section estimator configured to estimate a section in which an abnormality has occurred based on an abnormality estimation result of at least one of the plurality of sections obtained by inputting the signal data extracted by the optical signal monitors at the one or more monitoring points to trained models that are trained to receive the signal data as an input and output the abnormality estimation result.

8. An abnormal section estimation device provided in a system in which an optical transmitter and an optical receiver are connected by an optical transmission line,
the optical transmission line being divided into a plurality of sections at one or more monitoring points from the optical transmitter to the optical receiver, the abnormal section estimation device comprising:
an abnormal section estimator configured to estimate a section in which an abnormality has occurred based on an abnormality estimation result of at least one of the plurality of sections obtained by inputting signal data obtained by one or more optical signal monitors that extract the signal data at the one or more monitoring points to trained models that are trained to receive, as an input, the signal data on a complex plane of an optical signal expressed by a phase and an amplitude obtained based on the optical signal transmitted from the optical transmitter and to output the abnormality estimation result.
